(19) United States
(12) Patent Application Publication
(10) Pub. No.: US 2023/0339999 A1
(43) Pub. Date: Oct. 26, 2023

(54) RECOVERY OF HIGH-PURITY LIGNIN VIA SIMULTANEOUS LIQUID-PHASE ACIDIFICATION AND SOLVATION

(71) Applicant: CLEMSON UNIVERSITY, CLEMSON, SC (US)

(72) Inventors: MARK C. THIES, CLEMSON, SC (US); CARTER L. FITZGERALD, CLEMSON, SC (US)

(21) Appl. No.: 18/303,024

(22) Filed: Apr. 19, 2023

Related U.S. Application Data
(60) Provisional application No. 63/332,928, filed on Apr. 20, 2022.

(51) Int. Cl. B01D 11/04; C07G 1/00

(52) U.S. Cl. CPC C07G 1/00; B01D 11/0488; B01D 11/0492

(57) ABSTRACT

Methods for recovering lignins are described that include simultaneous acidification and solvation of lignin. A single step process is described that includes combining a lignin-containing feed with a solvent solution that includes both an organic solvent and a strong acid. Upon formation and heating of the resulting mixture, lignin in the feed can be acidified from the salt form to the acid form in conjunction with solvation of the acidified lignin through the creation of both a liquified lignin-rich liquid phase and a solvent-rich liquid phase in a liquid/liquid equilibrium (LLE).

### CROSS REFERENCE TO RELATED APPLICATION

This application claims filing benefit of U.S. Provisional Pat. Application Serial No. 63/332,928 having a filing date of Apr. 20, 2022, entitled “Continuous Recovery of High-Purity Kraft Lignin from Black Liquor via Simultaneous Liquid-Phase Acidification and Purification,” which is incorporated herein by reference for all purposes.

### FEDERAL RESEARCH STATEMENT

This invention was made with Government support under Award No. IIP-1701128, awarded by the National Science Foundation and under Award No. DE-EE0008502, awarded by the Department of Energy. The Government has certain rights in the invention.

### BACKGROUND

As a byproduct of cellulose isolation, Kraft lignin has historically been regarded as little more than furnace fuel to drive the recovery boilers. This trend is changing in recent years, however, as interest in chemical/material applications for lignin grows. As a renewable and relatively abundant biomaterial, lignin is potentially an economical substitute for petrochemicals in a range of applications. For example, lignin-based carbon fibers could sell for a fraction of the cost of carbon fibers formed from polyacrylonitrile (PAN), while polyurethane (PU) foams made from lignin could have improved microbial resistance and flame retardant properties versus conventional PU foams.

Three lignin-recovery processes have been reported in the literature and are either under development or have been commercialized: LignoBoost®, which includes carbonation with CO₂ and acidification with H₂SO₄ in conjunction with multiple washing and filter pressing steps to obtain a solid lignin product (Tomani, 2010); the LignoForce™ System, which incorporates a black liquor oxidation step to convert sulfur species to nonvolatile species in conjunction with the carbonation and acidification steps of other recovery processes and provides a solid lignin product (Kouisni et al., 2012); and SLRP™, a sequential liquid-lignin recovery and purification process that reduces CO₂ consumption in the carbonation step and separates lignin from the CO₂ carbonation step as a gravity-separated liquid phase, rather than as a precipitated solid (Hubbe et al., 2019; Lake and Blackburn, 2016; Velez and Thies, 2016). All three of these processes carbonate the black liquor via CO₂ sparging (during which the pH of the black liquor is reduced to about 9.5) and further acidify the resulting material with H₂SO₄. In the SLRP™ process the lignin recovered after the CO₂ carbonation step is referred to as “liquid-lignin” as it is separated as a liquid phase using a liquid-liquid equilibrium rather than precipitated as a solid lignin as in the other processes. The SLRP™ process uses elevated temperatures of operation (100-150° C.) and at pressures above the vapor pressure of the black liquor (5-15 bar), the lignin exists as a highly hydrated (and thus solvated) liquid phase, denser than the black-liquor solution and comprising 30-40% water by weight. This liquid-lignin can be continuously delivered to the next processing step simply by pumping. In contrast, solid precipitation based lignin-recovery processes require a filtration step to separate the solid lignin from the black-liquor solution.

All three of these recovery processes use sulfuric acid for an acidification step during which the pH is reduced from 9.5 to 2.5, converting the lignin from its salt (mostly sodium) to acid form according to the following reaction:

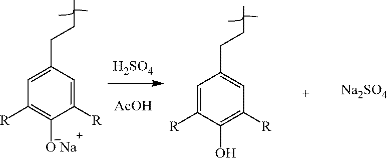

This acidification results in a reduction in the sodium/ash content of the lignin from about 5 wt.% Na and about 20% ash to about 8,000 ppm Na and about 2-3% ash. The resultant products from these processes are sold as Kraft (alkali) lignin.

Although these Kraft lignins can be used “as is” for a number of applications, including dispersants, specialty dyes, fillers, and binders, much cleaner lignins are required for other uses. For example, lignins suitable as precursors for carbon fibers must contain less than 200-250 ppm metals, as these impurities create flaws in the final fibers during the carbonization process. Lignin-based coatings applied via electrodeposition must be formed with similarly clean lignins. Moreover, activated carbons formed of very low ash lignins demonstrate improved CO₂ adsorption as compared to higher ash counterparts.

In response to such needs, methods for further purifying bulk lignins, including Kraft lignins and those recovered from biorefinery waste streams, have been developed. For instance an aqueous lignin purification process using hot agents (ALPHA) (Klett et al., 2015; Thies et al., 2018, U.S. Pat. No. 10,053,482, which is incorporated herein by reference) has been developed that can simultaneously clean and fractionate bulk lignins, including Kraft lignins. This process can utilize bulk lignin from any of the three recovery processes as a starting material and combines the feed lignin with a single-phase, aqueous organic solution at elevated temperatures, upon which a liquid-liquid equilibrium can be formed whereby most of the lignin coalesces as a solvated, lignin-rich liquid phase that is reduced up to tenfold in metals versus the feed lignin. Moreover, the molecular weight of the product lignin can be controlled by the fractionation of the lignin across the liquid phase. Through treatment of Kraft lignins with a multiple stage ALPHA process, an extremely pure lignin can be produced.

While the above describes improvement in the art, room for further improvement exists. What is needed in the art are methods for recovery of lignin. Moreover, methods that can provide lignin with a controlled molecular weight in a continuous recovery, purification, and fractionation process would be of great benefit to the art.

### SUMMARY

According to one embodiment, disclosed is a lignin recovery method that includes combining a feed containing lignin with a solvent solution to form a mixture. The feed includes the lignin and one or more impurities, e.g., metal salts, etc. The solvent solution includes a strong acid at a normality of from about 0.25 N to about 4 N, and an organic solvent in an amount of from about 20 wt.% to about 90 wt.% of the solvent solution. A method also includes heating and agitating the mixture, upon which the mixture separates to form a liquid-liquid equilibrium (LLE) that includes a lignin-rich phase and a solvent-rich phase, each of which including a portion of the lignin in a liquified form (i.e., liquified lignin). The lignin of the liquified lignin-rich phase will have a higher number average molecular weight than that of the solvent-rich phase.

In some embodiments, a method can include further processing of the lignin of the liquified lignin-rich phase to form an ultra-pure lignin. For instance, lignin of the liquified lignin-rich phase can be combined with a single phase organic solvent solution to form a mixture and this mixture can be stirred and heated, upon which the mixture will separate into a solvent-rich liquid phase and a lignin-rich liquid phase. This product lignin can be ultra-pure, with a very low content of impurities, e.g., a sodium content of less than about 100 ppm and an ash content of less than about 0.01 wt.%.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates an embodiment of a lignin recovery process as described herein.

FIG. 2 illustrates another embodiment of a lignin recovery process as described herein.

FIG. 3 illustrates one embodiment of a lignin preprocessing method as may be carried out prior to a recovery process as described herein.

FIG. 4 illustrates one embodiment of a lignin postprocessing method as may be carried out subsequent to a recovery process as described herein.

FIG. 5 illustrates the phase transition temperatures with organic solvent concentration and associated phase diagram for a lignin/solvent solution mixture using acetic acid as the organic solvent.

FIG. 6 illustrates the lignin yield in the lignin-rich phase with increasing organic solvent concentration at several different temperatures and constant strong acid concentration.

FIG. 7 illustrates lignin yield in each liquid/liquid equilibrium (LLE) phase with increasing strong acid concentration at constant organic solvent concentration and temperature.

FIG. 8 illustrates number average molecular weight of lignin in each LLE phase with increasing organic solvent concentration at several different temperatures and constant strong acid concentration.

FIG. 9 illustrates number average molecular weight of lignin in each LLE phase with increasing strong acid concentration at constant organic solvent concentration and temperature.

FIG. 10 illustrates sodium content of lignin from each LLE phase with increasing organic solvent concentration at several different temperatures and constant strong acid concentration.

FIG. 11 illustrates sodium content of lignin in each LLE phase with increasing strong acid concentration at constant organic solvent concentration and temperature.

FIG. 12 illustrates the phase transition temperatures with organic solvent concentration for a lignin/solvent solution mixture using ethanol, methanol, or acetic acid as the organic solvent and comparison with an ALPHA process.

FIG. 13 compares the lignin recovery in the lignin rich phase with increasing organic solvent concentration using methanol or ethanol as the organic solvent.

FIG. 14 compares the sodium content of lignin in the lignin rich phase with increasing organic solvent concentration using ethanol as the organic solvent.

FIG. 15 compares the sodium content of lignin in the lignin rich phase with increasing organic solvent concentration using methanol as the organic solvent.

FIG. 16 provides the effect of washing on the sodium content of the product for each system.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

In general, disclosed are methods for purifying lignins. More specifically, disclosed are methods for generating a liquified, clean lignin in a single step process during which the feed is simultaneously acidified and solvated. The single step process includes combining a lignin-containing feed with a solvent solution that includes both an organic solvent and a strong acid. Upon formation and heating of the resulting mixture, lignin in the feed can be acidified from the salt form to the acid form in conjunction with solvation of the acidified lignin across a liquified lignin-rich liquid phase and a solvent-rich liquid phase in a liquid/liquid equilibrium (LLE).

Simultaneous solvation and acidification of the lignin can significantly enhance mass transfer of impurities from the lignin, providing for a liquified lignin product that is greatly reduced in impurities (e.g., sodium and ash) as compared to the lignin of the feed. For instance, by use of disclosed methods a lignin product can be obtained that can be reduced in metals/ash content by a factor of from about 3 to about 5 as compared to conventionally obtained Kraft lignin. Moreover, solvation of the liquified lignin can fractionate the acidified liquified lignin across the phases of the LLE, providing for recovery of high purity lignins with well-defined molecular weights. In addition, the high purity of the lignin product can reduce the post-processing cleaning needs as compared to previously known processes, reducing water consumption and environmental footprint of a process.

Disclosed methods can provide for a continuous process for lignin recovery, purification, and fractionation. In one embodiment, the feed to a process can be black liquor and the process can be continuous (or semi-continuous) to provide a final lignin product with high purity and a well-defined molecular weight. Beneficially, all components of a process, including intermediates, can be maintained as easily processable (e.g., pumpable) liquids. Moreover, a lignin product of a process can be provided as a liquid or can be solidified to provide a solid product lignin, as desired.

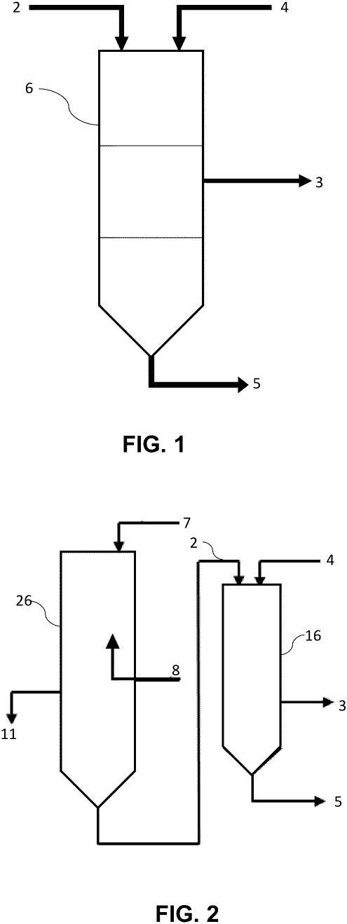

FIG. 1 schematically illustrates one embodiment of a single step lignin recovery process that incorporates simultaneous acidification and solvation of lignin. As indicated, a process can include combining a lignin-containing feed 2 and a solvent solution 4 within a vessel 6. Upon combination and heating of the mixture, a LLE can form in the vessel 6 including a solvent rich phase 3 and a liquified lignin rich phase 5, each of which can be removed from the vessel 6 in a continuous or batch process, as desired.

The solvent solution 4 is a single phase solution that includes both a strong acid component, to provide the desired level of acidification of the lignin of the feed, and an organic solvent component, to provide for the desired solvation of the lignin upon heating.

Organic solvents of the solvent solution 4 can include C₁ to C₈, e.g., C₁ to C₄, organic solvents that have at least one functional group in common with lignin such as, and without limitation, organic acids, aliphatic alcohols, ethers, ketones, ethyl acetate, and mixtures thereof. Organic acids as may be included in a solvent solution can encompass for example, formic acid, acetic acid, propanoic acid, butanoic acid, oxalic acid, ethyl acetate, etc., or mixtures thereof. Aliphatic alcohols as may be included in a solvent solution can encompass, for example, methanol, ethanol, propanols (e.g., isopropyl alcohol), butanols, or mixtures thereof. Examples of ethers and/or ketones as may be included in a solvent solution can encompass, for example, acetone and higher ketones.

The organic solvent component can typically constitute from about 20 wt.% to about 90 wt.% of the solvent solution, such as from about 30 wt.% to about 80 wt.%, such as from about 40 wt.% to about 75 wt.%, such as from about 45 wt.% to about 70 wt.%, such as from about 50 wt.% to about 65 wt.%, such as about 55 wt.% of the solvent solution in some embodiments.

In conjunction with the organic solvent component, the solvent solution 4 can include a strong acid component, e.g., sulfuric acid, hydrochloric acid, nitric acid, etc. as well as any combination thereof. The strong acid component can be provided to the solvent solution at a normality of from about 0.2 N to about 4 N, such as from about 0.5 N to about 3 N, such as from about 1 N to about 2.5 N, such as about 2 N in some embodiments.

According to disclosed methods, a solvent solution 4 can be combined with a lignin-containing feedstock 2 to form a mixture. The feedstock can be derived from a lignin-containing feedstock, and can include an alkaline lignin-containing liquor, e.g., a black liquor, a solid lignin previously separated from a black liquor, or pre-treated black liquor (e.g., a carbonated liquor). The lignin-containing feedstock 2 can be derived from a range of lignocellulosic biomass source materials, including both woody and non-woody sources. Woody lignocellulosic biomass can be sourced from forests, agriculture, or any other source and can encompass hardwood and/or softwood source materials. For example, fast-growing tree species such as hybrid willow (Salix) and poplar as have been developed for production in agricultural settings can be utilized. Perennial and annual grasses can provide non-woody lignocellulosic source materials. Examples of grass source materials can include, without limitation, switchgrass (Panicum virgatum), miscanthus (Miscanthus spp. Anderss.), canary grass (Phalaris arundinacea), giant reed (Arundo donax L.), alfalfa (Medicago sativa L.), sorghum (Sorghum bicolor) and Napier grass (Pennisetum purpureum).

Agriculture systems can be a source of non-woody lignocellulosic biomass source materials. Agricultural systems can produce several different types of non-woody lignocellulosic biomass materials including primarily cellulosic materials such as plant leaves and higher lignin-content materials such as stems and stalks. Harvesting of cereals, vegetables, and fruits can provide lignocellulosic biomass source materials. Agricultural residues including field residues and processing residues can provide lignocellulosic source materials. Field residues include materials left in an agricultural field after harvesting the crop, and can include, without limitation, straw and stalks, leaves, and seed pods. Processing residues, such as husks, seeds, bagasse and roots, include those materials left after the processing of the crop into a desired form. Examples of agricultural residue source materials can include, without limitation, rice straw, wheat straw, corn stover, and sugarcane bagasse.

Other waste streams such as municipal waste, industrial waste, construction waste, sawmill waste, etc., can provide a lignocellulosic biomass source material. For instance, yard waste, holiday waste, etc. can provide a lignocellulosic source material in some embodiments.

The lignin-containing feedstock 2 can generally include lignin that has been previously separated from other components of a source material, such that the cohesive structure of the natural biomass source material has been altered by the pretreatment. However, the feedstock can still include one or more components of the lignocellulosic biomass source material(s) in combination with the lignin as well as one or more residual components of a pretreatment process. For instance, the feedstock 2 can include lignin in an amount of about 30 wt.% or greater, such as about 40 wt.% or greater, such as about 50 wt.% or greater in some embodiments. Processes are not limited to high lignin-content feedstocks, however, and in other embodiments the feedstock can include lignin in an amount of about 30% or less.

In one embodiment a black liquor stream of a Kraft process can provide the lignocellulosic biomass feedstock 2. FIG. 2 illustrates one embodiment of a process that includes a pretreatment stage for a Kraft black liquor feed 7 prior to the single step recovery disclosed herein. In one such embodiment a carbonation pretreatment such as that described by Lake, et al. (U.S. Pat. No. 9,260,464, incorporated herein by reference) can be carried out prior to the recovery.

Briefly, a pretreatment carbonation can include feed to the system of a black liquor 7 at a pH between 12 and 14 that can be pressurized to between 50 and 200 psig. As an optional step, oxygen may be reacted with the black liquor 7 to reduce and/or eliminate odors. The pressurized black liquor 7 is introduced into an absorption column 26 within which the black liquor 7, which is at an elevated temperature and pressure, is counter-currently treated with CO₂ 8. For instance, the column 26 can operate at a nominal pressure of about 150 psig and a temperature between about 80° C. and about 200°. The CO₂ carbonation treatment can reduce the pH of the black liquor to between about 9 and 10 and partially neutralizes the NaOH and other basic components of the black liquor. The carbonation also converts much of the sodium (and other metals) of phenolic groups on the lignin molecules to the hydrogen form, causing the lignin to become less soluble. The carbonated material undergoes a phase separation creating a dense lignin-rich “liquid lignin” phase 2 and a light lignin-depleted phase 11. In one embodiment, the light lignin-depleted phase 11 can be returned to a recovery process of a host paper mill. The liquid lignin phase 2 can be retained at conditions to maintain the lignin as a liquid phase so as to be pumped to vessel 16, within which it can be combined with a solvent solution as described and subjected to a single step recovery process as described herein.

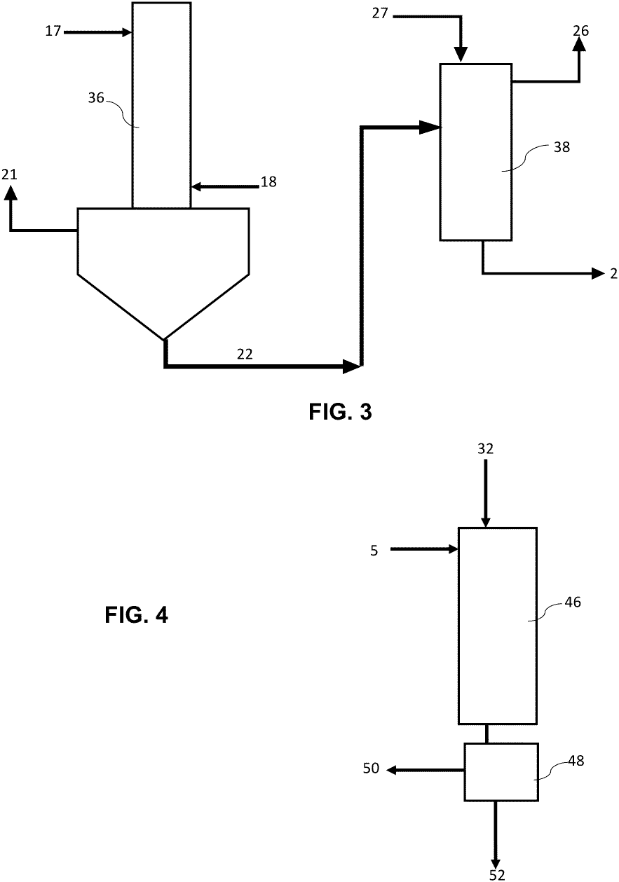

In one embodiment, disclosed methods can be utilized in conjunction with existing lignin recovery processes. For instance, a single step recovery process can be added to the back end of an existing lignin recovery process. In one such embodiment, a single step recovery process can be added to the back end of a SLRP™ process, an example of which is described by Lake et al. (U.S. Pat. No. 9,260,464, previously incorporated herein by reference). As illustrated in FIG. 3, according to this process, a feedstock 17 (e.g., a black liquor) can be precipitated by reduction of the pH of the alkaline liquor stream 17 via countercurrent reaction with carbon dioxide 18 at elevated temperature and pressure, which can provide a liquid lignin stream 22, as described above. The lignin-depleted phase 21 can be returned to a host paper mill. The lignin rich solution 22 leaving the bottom of the carbonation column 36 contains approximately 30-40% water and is transferred to a mix tank 38 where the solution 22 is washed with a strong acid 27, such as sulfuric acid, to neutralize residual NaOH. During this acidification step the pH is reduced to a pH less than 4, such as from about 1.5 to about 3.5. An agitator within the mixing tank 38 can provide a high level of mixing within a short residence time. The acidifying step can be carried out at a temperature up to 200° C. to form a solid lignin phase 2 that can be fed directly to a single step recovery as described herein. The spent acid 26 can be returned to a host paper mill for recycle. When the acidifying temperature is lower, e.g., between about 90° C. and about 130° C., lignin granules can be formed and the separated granules can be heated, optionally at increased pressure, to form a lignin-containing feed 2 for a single step recovery process.

Pretreatment of a lignin-containing feed 2 is not limited to these exemplary embodiments, and other pretreatment processes that produce a lignin-containing feed 2 and that can be carried out prior to the disclosed processes can include, without limitation, those described in U.S. Pat. No. 4,908,098 to DeLong, et al., U.S. Pat. No. 6,022,419 to Torget, et al., U.S. Pat. No. 8,657,960 to North, et al., U.S. Pat. No. 8,663,392 to Zhang, et al., and U.S. Pat. Application Publication No. 2014/0163210, all of which are incorporated herein by reference. Moreover, a single pretreatment process can be carried out or multiple processes, as desired. Examples of separation methods that can be utilized to pretreat lignocellulosic biomass can include, without limitation, alkaline treatment, acidic treatment, organosolv treatment, oxidative delignification, biological methods, and microwave irradiation, among others.

Referring again to FIG. 1, the lignin-containing feedstock 2 and the solvent solution 4 can be combined within a vessel 6 within which they can be stirred or mixed by any device as is generally known in the art. By way of example, a continuous process can be carried out in which a static mixer vessel 6 in which a black liquor fedstock 2 containing e.g., about 40% to about 60% by weight water can be pumped and combined with a solvent solution 4. The solvent solution 4 and the lignin containing feedstock 2 can be combined such that the total solvent content (including all water) and the total lignin plus impurities of the feed 2 are introduced to the vessel 6 a wt./wt. ratio of from about 3:1 to about 20:1, such as from about 4:1 to about 15:1, such as from about 5:1 to about 10:1, or such as about 6:1 in some embodiments. Upon combination, the mixture can be agitated in the vessel 6 in conjunction with heating, upon which the lignin of the feed 2 can be subjected to acidification and can simultaneously solvate, and the mixture can separate to form an LLE including a solvent-rich phase 3 and a liquified lignin-rich phase 5.

The mixture within the vessel 6 can be heated to promote the liquid fraction formation and maintain the lignin as liquified lignin. For example, a mixture can be heated to a temperature of about 30° C. or greater, about 50° C. or greater, about 70° C. or greater, or about 90° C. or greater in some embodiments to fully solvate the lignin and obtain a phase separation of the mixture into two liquid phases. In any case, the temperature and optionally the pressure can be raised as necessary such that both phases contain liquids at pressures above vaporization conditions. The upper limit of the temperature is not particularly limited and can be, for instance, about 300° C. or less, about 250° C. or less, about 200° C. or less, about 150° C. or less, or about 100° C. or less in some embodiments, with the pressure being increased as needed to prevent evaporation of any of the solvent components so that both liquid phases are kept intact.

The pressure of the system can be maintained at atmospheric until the temperature approaches the boiling point of the overall mixture. However, in some embodiments, the pressure can be increased to avoid vaporization of components of the system.

The lignin-rich phase 5 can generally be lower in impurities as compared to the solvent-rich phase 3. For instance, following a single step recovery, and depending upon the characteristics of the lignin-containing feedstock 2, the lignin-rich phase 5 can contain about 1 wt.% or less ash and a total metals content of about 2000 ppm or less.

In addition, the solvent-rich phase 3 can include lower molecular weight lignin as compared to the lignin-rich phase 5. For instance, following a single step recovery of a relatively wide molecular weight range of lignin, the solvent-rich phase 3 can include a relatively higher proportion of low molecular weight and very low molecular weight lignin and the lignin-rich phase 5 can include a relatively higher proportion of mid-range molecular weight and high molecular weight lignin.

As utilized herein, high molecular weight lignin can generally be considered as having a number average molecular weight of about 10,000 or greater, a mid-range molecular weight lignin can have a number average molecular weight of from about 5,000 to about 10,000, a low molecular weight lignin can have a number average molecular weight of from about 1,000 to about 5,000, and a very low molecular weight lignin can have a number average molecular weight of less than about 1,000. Number average molecular weights can be determined according to a gel permeation chromatography (GPC) analysis calibrated with monodisperse poly(ethylene glycol)/poly(ethylene oxide) molecular standards (Part No. PL2080-0201, Agilent). For example, the GPC setup can use a Styragel HT4 (Waters) column followed by a Polar Gel L (Agilent) column, the mobile phase can be dimethylformamide (DMF) + 0.05 M lithium bromide at a flow rate of 1 mL/min, and UV detection can be at 280 nm.

A liquified lignin of a single step recovery process can be further treated according to a post-processing method, in some embodiments. For instance, in one embodiment, a single step recovery process can be combined with a post-processing method to obtain a lignin product of ultrahigh purity (e.g., about 0.01 wt.% ash or less and a sodium content of about 100 ppm or less) and controlled molecular weight. Such ultrahigh purity lignin can be desired for higher-value applications, such as formation of carbon fibers, polyurethane foams, high absorbing activated carbons, etc.

In one embodiment, a post-processing treatment can include an ALPHA process, an example of which is described in U.S. Pat. No. 10,053,482 to Thies, et al., which is incorporated here by reference for all purposes. Briefly, and as illustrated in FIG. 4, an ALPHA process can include combining a purified liquified-lignin stream, e.g., the liquified lignin-rich stream 5 from the recovery process as described with an organic solvent 32, optionally under increased temperature and pressure. The organic solvent 32 can be the same or different than the organic solvent utilized in the single step recovery process. For instance, in one embodiment, both a single step recovery process and a post-treatment ALPHA process can utilize an acetic acid organic solvent. In such an embodiment, the acetic acid solvent phase from the recovery stage can be recycled, for instance after adjusting the acetic acid/water ratio and metal salts via minimal distillation, to serve as the solvent feed for a follow-on ALPHA process.

The mixture including the liquified lignin and the organic solvent can be combined and optionally heated within a mixer 46, and then pumped to a settler 48, within which the mixture including the solvated lignin in the solvent solution separates to form a first solvent-rich liquid phase in a first fraction 50 and a second lignin-rich liquid phase in a second fraction 52. When the mixture is heated, it can generally be heated to a temperature of about 30° C. or greater, about 50° C. or greater, about 70° C. or greater, or about 90° C. or greater in some embodiments to fully solvate the lignin and obtain a phase separation of the mixture into two liquid phases. The temperature and optionally the pressure can be raised as necessary such that both phases contain liquids beneath vaporization conditions. The upper limit of the temperature is not particularly limited and can be, for instance, about 300° C. or less, about 250° C. or less, about 200° C. or less, about 150° C. or less or about 100° C. or less in some embodiments, with the pressure being increased as needed to prevent evaporation of any of the solvent components so that both liquid phases are kept intact. The ALPHA process can be carried out one or multiple times with one or both fractions to provide ultrapure lignins with well controlled molecular weights.

Additional post-processing procedures as may be carried out can include washing processes, as are generally known in the art. Beneficially, due to the removal of impurities in the disclosed process, a washing process can be carried out with less water as compared to washing processes for previously known lignin recovery process. For instance, washing can be carried out using water added to a separated lignin in an amount of about 1:1 wt./wt. ratio. As such, washing requirements for obtaining lignin with very low ash/metals content can be much lower than the multiple (15-20) washing steps required by other means to obtain a similarly clean Kraft lignin.

The present invention may be better understood with reference to the examples set forth below.

### Example 1

A Southeastern pine Kraft black liquor with a pH of 13.5, Kappa no. of 29, solids content of 42 wt.%, total lignin content of 20 wt.%, and ash content of 37 wt.% was obtained from a Southeastern U.S. pulp mill. Compressed carbon dioxide (Coleman grade, 99.99% min) for acidifying the black liquor was obtained from Airgas USA. Glacial acetic acid (VWR cat. no. BDH3098-3.8LB), molecular biology grade 200 proof ethanol (Fisher Scientific cat. no. BP28184), and 95-98% sulfuric acid (Fisher Sci. cat. no. A300-212) were obtained. Deionized water (resistivity > 18.2 MΩ-cm) was obtained from a Culligan™ deionization system followed by a Milli-Q™ reference system (Millipore Z00QSV0WW) to produce Type 1 water. For GPC analysis, lithium bromide (cat. no. 35705-14) and HPLC grade (99.7+%) N,N-dimethylformamide (cat. no. 22915-K7) were obtained from VWR.

The Kraft black liquor was diluted from the starting 42 wt.% to 35 wt.% by the addition of water to approximately 1600 g of black liquor in a 2-L Parr pressure reactor (Model 4541). The reactor body had a custom-made, 45°- conical bottom, and a helical ribbon impeller operating at 60 rpm was used for agitation. After mixing the water and black liquor together for 15 min, the reactor head space was purged with nitrogen. The system pressure was then maintained at 50 psig over the entire course of the experiment in order to minimize the evaporation of water into the gas phase.

The diluted black liquor was then heated to 120 ±5° C. Once temperature was reached, carbonation commenced with the addition of CO₂ via sparging into the liquor at 250 std mL/min (Brooks 5850 mass flow meter and 5878 Controller). All gases exiting the reactor were vented into a hood, as poisonous H₂S gas was generated from the acidification reaction. The carbonation step resulted in formation of liquid-lignin as the pH dropped from 13.5 to 9.5. To monitor the pH, samples were taken through a dip tube in the reactor. Once the pH reached 9.5, agitation and CO₂ feed were discontinued, and the dense, viscous, liquid-lignin phase that had formed was allowed to settle at temperature and pressure for 2 h.

After obtaining a clean separation of the liquid-lignin phase from the spent black-liquor phase, the reactor was cooled to 65° C. and depressurized. The spent black liquor was then decanted off. Recovery of the liquid-lignin, which has a melting point of ~105° C., was simplified by allowing it to cool and solidify. The solidified liquid-lignin was then removed from the reactor and collected. In order to determine the overall solvent composition of the system, the water content of the original liquid-lignin phase was determined by Karl-Fischer titration to be 48.1 + 0.2 wt.%.

Acetic acid (AcOH) concentrations ranging from 0 to 80 wt.% of a solvent mixture consisting of AcOH, H₂SO₄, and H₂O were evaluated. The evaluation was carried out in a 9.5-dram glass vial (VWR cat. no. 66012-066) containing a magnetic stir bar of appropriate size (e.g., Fisher, part no. 14-512- 121, 9.5 mm o.d. x 10 mm long). The temperature of the contents of the vial were measured with a 1/16″ o.d., grounded, K-type thermocouple (Omega cat. no. CASS-116G-12), which was inserted into the lignin-solvent mixture through a pre-pierced septum cap (VWR part no. 89042-292). The thermocouple was calibrated to within 0.2° C. accuracy using the boiling point and freezing point of water. Vials were immersed so that the mixture level was ~½ in. below that of the oil bath (Dow Corning 200 silicone heat transfer fluid, a poly(dimethylsiloxane), which was heated with a 200 W quartz heater (Glo Quartz Electric, LHP200) and temperature-controlled with an OMEGA Series CN370 controller. For sample preparation, stock solutions consisting of acetic acid mixed with a 2N H₂SO₄ solution in water were used. Approximately 2 g of the previously formed solidified liquid-lignin were added to the vial, and solvent was added to create a 6:1 solvent-to-lignin wt/wt ratio. The water content of the solidified liquid-lignin added to the vial was accounted for during preparation of the stock solution. Vials were stirred continuously at about 120 rpm and heated at about 2° C./min. As the particles began swelling, the vial was periodically removed from the bath for about 5 s to examine its contents (the solvent phase was relatively dark) and thus more precisely determine the temperature at which the lignin particles liquefied and then coalesced (within about 2-3 s) to form a separate liquified-lignin phase. (These quick looks had no discernible effect on the temperature of the contents of the vial.) The observed phase transition was from solid liquid-lignin in solvent to liquefied lignin in solvent, that is, from solid-liquid equilibrium (SLE) to liquid-liquid phase equilibrium (LLE). For each phase-transition observation, experiments were performed in duplicate.

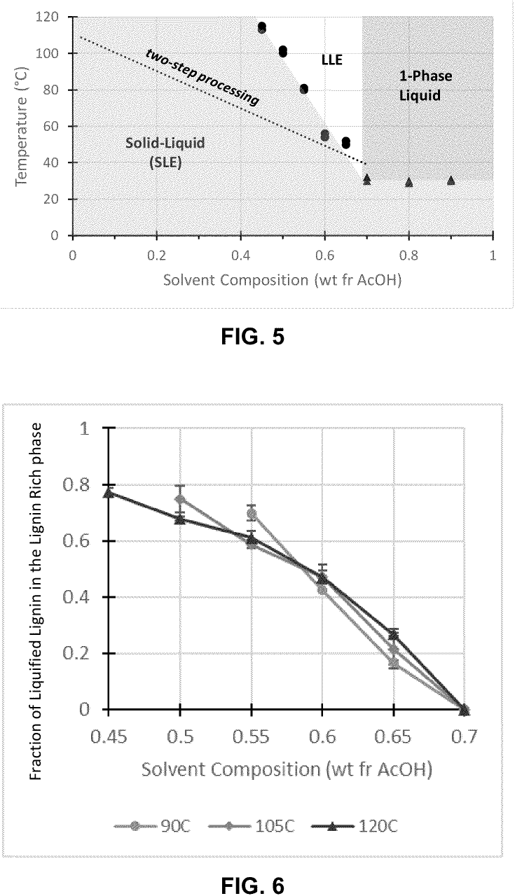

The results are shown in FIG. 5. In the figure, the dark circles denote the one-step phase transition of the solidified liquid-lignin directly from SLE to LLE. The dotted line denotes the conversion of (solid) lignin obtained via a SLRP™ process to liquefied lignin via the ALPHA process. The dark triangles denote the direct transition from SLE to a one-phase liquid, with no formation of a LLE. All measured data including duplicates are shown.

The results confirmed that a solvated liquified-lignin phase can be generated directly from SLRP™-derived liquid-lignin by combining H₂SO₄ acidification and AcOH-water solvation into a single step. Note from the figure that when neat 2N H₂SO₄ (i.e., 0.0 wt.fr. AcOH) was used, solid lignin particles precipitated out in the acid solution in solid-liquid equilibrium (SLE). This solid lignin is the conventional SLRP™ lignin product. At the examined conditions, only SLE existed until the composition reached 45 wt.% AcOH, at which point 45% of the 2 N H₂SO₄ solution had been replaced with AcOH. At this composition and at approximately 115° C. was the first appearance of liquefied lignin in LLE, as the solid lignin particles liquified in the presence of the AcOH-fortified solution. As the wt.% AcOH in the solvent was further increased, the temperature at which the lignin liquefied decreased rapidly, approximately 3.4° C. for every mol.% increase in AcOH concentration. This region of LLE continued until 70 wt.% AcOH, where the phase transition became that which typically occurs for solid/liquid mixtures, i.e., the solid lignin directly dissolved in the solvent (here, at 31 ±1 ºC), with no intermediate LLE step, to form a single liquid phase.

This phase behavior created by one-step strong acid/organic solvent processing was compared with that obtained by a two-step process, consisting of a SLRP™ process (treatment via CO₂ carbonation followed by H₂SO₄ acidification) and an ALPHA process (using AcOH as solvent) as two separate steps in which the lignin is first converted into SLRP™ lignin (a solid) via 2 N H₂SO₄ acidification, and then the SLRP™ lignin is liquefied with AcOH-water mixtures to create a purified “ALPHA” lignin. As shown in FIG. 5, two-step processing does expand the region of LLE, with aqueous AcOH concentrations as low as 10 wt.% (at 100° C.) being effective for liquefying the lignin. The dependence of phase-transition temperature on AcOH concentration is also markedly less, with the temperature dropping only 1.0° C. per mol % increase in AcOH concentration. Interestingly, for both the one-step and two-step methods, the LLE region disappears at approximately 70 wt.% AcOH and is replaced with a single liquid phase.

Differences in phase behavior between the two processing methods can be explained as follows: Because the liquid-lignin being fed to the one-step disclosed herein is precipitated directly from the black liquor with CO₂, it undergoes only a mild acid precipitation, that is, with carbonic acid. Thus, it has a relatively high Na content of 55,000 ±2500 Na (equivalent to about 20 % ash). Although this is much less than the 20% Na/50% ash content of the starting black liquor, a significant percentage of the hydroxyl groups are still in their Na-salt form. This excess sodium would be expected to have an impact analogous to the “salting out” effect observed with proteins (Bailey and Ollis, 1986); thus the SLE region is much larger than the LLE region when SLRP™-derived liquid-lignin is the feed. In contrast, the SLRP lignin fed via two-step processing contains only approximately 8000 ppm Na, so most OH groups are in their acid form. Aggregation of the lignin, and thus formation of the liquefied-lignin phase, is therefore favored, as attractive (i.e., dispersive) forces dominate. Nevertheless, having a smaller LLE region to work with can be of significant benefit, as it enables the continuous processing of lignin from black liquor to a clean lignin product in a single processing step.

### Example 2

Once the region of LLE had been identified, lignin yields and properties for both of the resultant phases were determined. For these experiments, a 50-mL Parr reactor (Part no. 2430HC2) was used in lieu of vials, so that adequate amounts of material would be available for analysis. The pressurized reactor also enabled operation above the normal boiling point (~105° C.) of the solvent mixtures. AcOH concentrations in H₂SO₄ solutions (typically 2N) were prepared as described above, except now AcOH concentrations were limited to the LLE region as shown in FIG. 5. For a typical experiment, about 10 g of solidified liquid-lignin obtained following the initial carbonation process was added to the reactor, along with the amounts of glacial AcOH and H₂SO₄ required to make up the desired weight fraction of acetic acid, normality of sulfuric acid, and solvent-to-lignin ratio of 6:1. The reactor was heated to the selected temperature (90° C., 105° C., or 120° C.) within 5-10 min under agitation at 100 rpm; then the contents were allowed to equilibrate under agitation for 15 min. Phase separation between the solvent and the liquefied-lignin phases that formed was essentially immediate after the cessation of agitation. After allowing the reactor to cool for 2-5 min to 75° C. so as to facilitate handling, the less-dense solvent phase was decanted off. The liquefied-lignin phase was recovered, including scraping it off both the impeller and the bottom of the reactor.

The lignin in each phase was isolated to determine lignin distribution between the phases. Lignin was recovered from the solvent phase by adding DI water to that phase in a 1:1 wt/wt water/phase ratio, thus precipitating out the lignin as a solid. The lignin was then isolated using a Buchner funnel with a cellulose filter (cat. no. 09-790-4C). Lignin was recovered from the liquefied-lignin phase by again using a 1:1 wt/wt DI water/phase ratio. The resultant slurry was then thoroughly mixed in a blender to ensure the complete removal of sulfuric acid from the precipitated solid lignin particles. The solid lignin was then isolated via the Buchner funnel setup described above.

The lignin recovered from each phase was allowed to dry overnight in a fume hood down to about 5 wt.% water, with the water content of the lignin being determined via Karl-Fischer titration. Mass balances on the initial mass of lignin vs. the sum of the amounts recovered in both the solvent and liquefied-lignin phases closed on average to better than ±8%.

Metals analyses of the dried lignin samples from the liquefied-lignin and solvent phases, as well as from the liquid-lignin feed, were carried out using inductively coupled plasma atomic emission spectroscopy (ICP-AES). Analyses were carried out using an Ametek Spectro Scientific spectrometer, model ARCOS. Samples were air-dried and then vacuum-dried to remove water as completely as possible, as any residual water would be considered part of the lignin mass.

Dried lignin samples from the liquefied-lignin and solvent phases were analyzed by gel permeation chromatography (GPC) to determine the extent of fractionation by molecular weight. GPC was also used to look for evidence of increases in lignin molecular weight due to acetic acid-catalyzed condensation reactions. GPC separation was achieved using a Waters Styragel HT 5 column followed by an Agilent PolarGel-L column, using a mobile phase consisting of dimethylformamide (DMF) plus 0.05 M LiBr at a flow rate of 1 mL/min. Samples were prepared by dissolving lignin in the mobile phase at a concentration of 1 mg/mL and filtered using a 0.2 µm PTFE membrane syringe filter (VWR cat. no. 28145-291). The instrument was calibrated with polyethylene glycol (PEG) standards on a refractive index detector, and the lignin samples were detected using a Waters 996 UV-vis PDA detector at 280 nm.

The hydroxyl content of selected lignins and lignin fractions was determined using phosphorus nuclear magnetic resonance (³¹P NMR) spectroscopy. Three lignins were analyzed: SLRP™ liquid-lignin, commercial BioChoice ™ lignin, and the liquefied-lignin phase from the disclosed process.

In determining the effect of the sulfuric acid concentration on the formation of the liquified-lignin phase, the AcOH concentration was held constant at 55 wt.% of the total solvent, and the effect of changes in H₂SO₄ normality on lignin yields and properties was explored. The 50-mL Parr reactor and methods described above were used. Experiments were performed at 90° C.

The fraction of lignin from the liquid-lignin feed contained within the lignin-rich, liquefied-lignin phase (i.e., yield) with change in solvent concentration and at the three different temperatures examined with sulfuric acid concentration held constant at 2 N is shown in FIG. 6. Error bars are for one standard deviation. The trendlines are included to help guide the eye. As shown, the effect of temperature on lignin yields in the liquefied-lignin phase was relatively small.

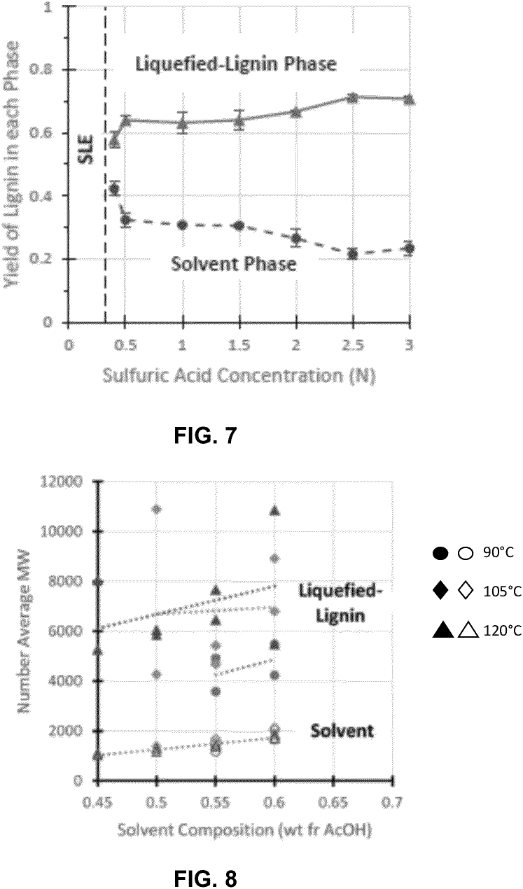

FIG. 7 compares the lignin yield in each phase with sulfuric acid concentration with AcOH concentration held constant at 55 wt.% of the solvent solution and the separation being run at 90° C. As shown, below about 0.4 N H₂SO₄, insufficient Na was removed from the lignin to enable its solvation by the AcOH—H₂O solution; thus, only SLE existed at these conditions. However, at only 0.5 N, sufficient Na removal occurred so that attractive (dispersive) forces between the lignin moieties became dominant, and the desired liquefied-lignin phase could form. Error bars are for one standard deviation. The trendlines are included to help guide the eye.

Number average molecular weights (Mₙ) with change in solvent composition for the lignin that precipitated out in the liquefied-lignin phase, versus that which remained dissolved in the solvent phase, are presented in FIG. 8. Values obtained at each of the different temperatures examined and at constant sulfuric acid concentration of 2 N are shown. For the liquefied-lignin phase, the trend, as shown by the linear regressions plotted for each temperature, is one of increasing molecular weight, both with increasing temperature and AcOH concentration. However, the scatter in molecular weight (MW) is large. Typically, more scatter in MW measurements for lignins recovered from the lignin-rich liquid phase are observed — in both the liquid-lignin phase of SLRP™ as well as in the lignin-rich liquid phase of ALPHA purification processes. This phenomenon is attributed to the increased tendency of the higher-MW lignin molecules to aggregate, especially when they are initially present in a phase rich in lignin polymer (e.g., >50 wt.%), so that entanglement is more likely to occur. The large scatter for this phase in FIG. 8 indicates that this aggregation effect was more pronounced in this one step process.

Without wishing to be bound to any particular theory, it is believed that the increase in molecular weight of lignin in the liquefied-lignin phase with temperature as indicated in FIG. 8 is due to two complementary effects: (1) The yield of lignin in the liquefied-lignin phase decreases with increasing AcOH concentration as the solvent phase becomes more powerful and as a result, only the higher MW lignins remain undissolved in the solvent and phase-split to form a separate liquid phase; and (2) Acid-catalyzed condensation reactions are favored in the lignin-dense, liquefied-lignin phase, as the lignin molecules are in intimate contact. Additionally, higher temperatures tend to accelerate these reactions.

For the lignin dissolved in the solvent phase, no significant effect of temperature was seen (FIG. 8). Condensation reactions are minimal, as the lower MW lignin is dissolved in (and thus surrounded by) solvent molecules. This is in contrast with the situation in the liquefied-lignin phase, where the solvent is dissolved in (i.e., plasticizes) the lignin. In fact, the modest increase in molecular weight with AcOH concentration observed in the solvent phase can be explained solely by the yield of lignin in the solvent phase more than tripling between 45 wt% and 60 wt.% AcOH in the solvent solution, as the higher MW lignin becomes increasingly soluble in the solvent phase.

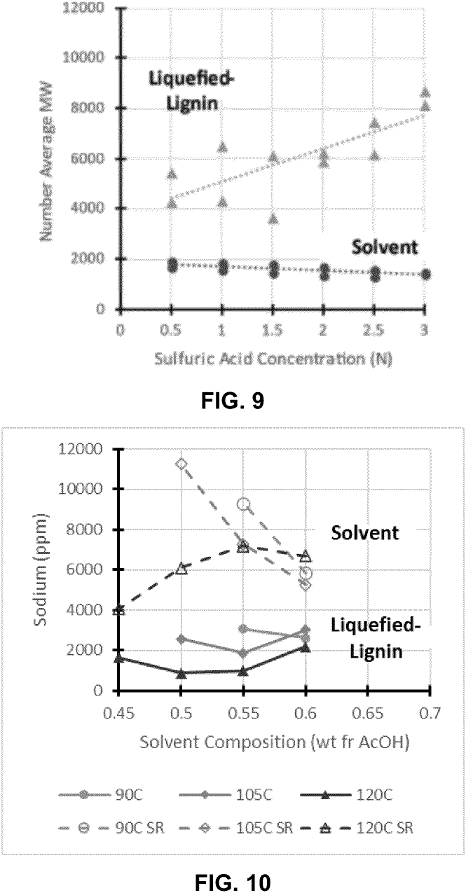

The effect of H₂SO₄ concentration on the molecular weight of the lignin in each LLE phase is shown in FIG. 9. In obtaining these values, AcOH was held constant at 55 wt.% and the temperature at 90° C. Consistent with the above discussion, an increase in the lignin molecular weight in the lignin-rich, liquefied-lignin phase was seen, but no change in the lignin-poor, solvent phase. These results lend further credence to the hypothesis that acid-catalyzed condensation reactions are at least partially responsible for the observed increases in lignin molecular weight.

³¹P NMR spectroscopy indicated no significant structural differences in OH content, whether aromatic, aliphatic, or carboxylic, between the three evaluated lignins, all derived from Southeastern Southern pine black liquor: (1) a liquefied lignin recovered by the disclosed one step process at 120° C. using 45% acetic acid in a 2 N H₂SO₄ solution, (2) a SLRP™ liquid-lignin control, and (3) a BioChoice™ lignin obtained from Domtar Corporation. The liquefied lignin with a yield approaching 80% obtained according to the disclosed process was chosen for comparison with the other two products, as it should contain about 80% of the same lignin molecules originally present in the “parent” SLRP™ liquid-lignin control, assuming no changes in the structure of individual lignin species due to chemical reactions. The results support the hypothesis that reactions between lignin moieties to effect structural changes are relatively rare, and that the dominant effect of the disclosed process is the separation of lignin species into two distinct liquid phases due to entropic and enthalpic effects.

The effect of increasing AcOH concentration on the sodium content of the lignin recovered from each LLE phase is given in FIG. 10. For the liquefied-lignin phase, the highest temperature (120° C.) consistently resulted in lower levels of Na. At 45% AcOH, where lignin yields approach 80% (see FIG. 6), the sodium content of the dried lignin recovered from the liquefied-lignin phase was 1700 ppm Na (equivalent to about 0.8% ash). At 50 and 55% AcOH, the sodium content in the liquefied-lignin phase was reduced to 1000 ppm (about 0.5% ash), albeit with some drop in lignin yield. Thus, a significant fraction of very clean lignin can be obtained from the starting liquid-lignin at these conditions. In particular, these Na levels represent a reduction in Na by a factor of about 25 (i.e., from 55,000 ppm Na) over those present in the liquid-lignin phase from SLRP™ (or from the intermediate solid lignin phase in LignoBoost™ or LignoForce™ processes), and a reduction by 3-4 over the levels typically present in a commercially available Kraft lignin (7000-8000 ppm). On the other hand, even higher AcOH levels (about 60% and above) can create an increasingly organic solvent phase that, in combination with lignin yields falling below 50%, can lead to increased sodium levels in the dried, liquefied-lignin phase.

With respect to the solvent phase results shown in FIG. 10, previous studies with lignin-solvent-water systems have shown that Na results for the phase dilute in lignin (here, the solvent phase) can be in significant error vs. those derived from an overall Na balance using the Na content of the feed and liquefied-lignin phases, both of which have proven to be reliable. Such a Na balance could not be performed because each phase was water-washed before drying to remove the H₂SO₄, which also removed a portion of the Na. For example, the solvent phase typically consists of 1-5 wt.% lignin and thus is concentrated by a factor of 20-100 by drying, resulting in high Na numbers. As shown in FIG. 10, this combination of washing and drying resulted in a wide range of values for Na content. However, qualitatively the trends are correct: When the Na content went “up” in one phase, it went “down” in the other, and vice versa — as it must to satisfy the overall Na mass balance.

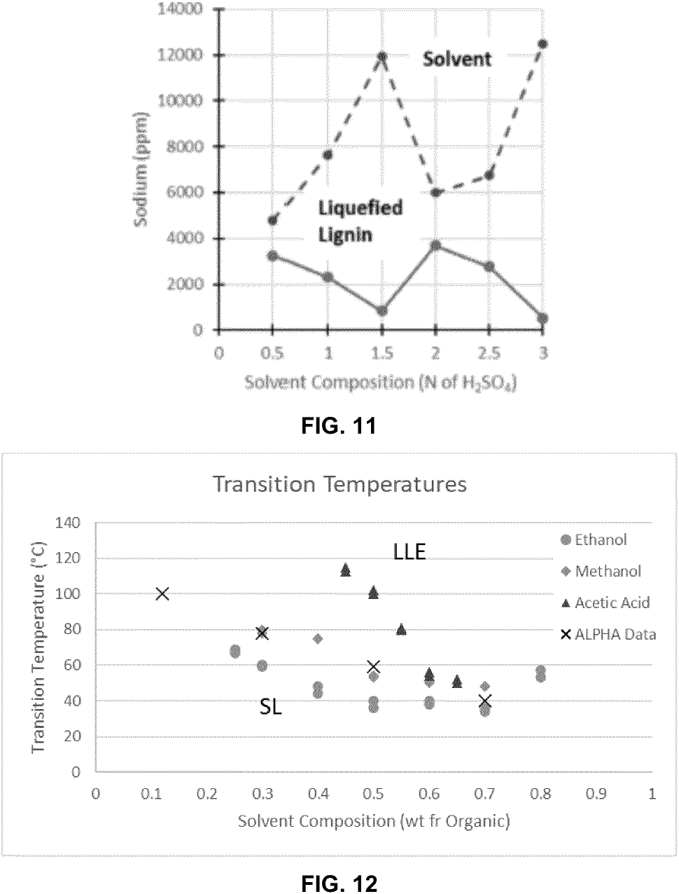

Referring to FIG. 11, the effect of H₂SO₄ concentration on the Na content in each LLE phase was also investigated. Fortunately, only moderate levels of H₂SO₄ were required to achieve low levels of Na in the liquefied-lignin phase, with 1.0-1.5 N H₂SO₄ providing good results under the examined conditions. The surprising minimum/maximum behavior in Na content for the liquefied-lignin phase, which appears to be a case of competing effects, was reproducible. As evident in FIG. 10, the Na content of the two phases qualitatively tracked each other “up and down”, and there were large variations in the Na content of the solvent phase due to sample-concentration effects.

### Example 3

The single step method described herein was carried out using a liquid-lignin obtained as described above as a starting material. The solvent mixture included 1.5 N H₂SO₄ and either methanol (MeOH) or ethanol (EtOH) as the organic solvent.

The phase transition temperatures between a solid/liquid equilibrium system and an LLE system are shown in FIG. 12. For comparison, the figure also includes phase transition temperatures obtained using AcOH as the organic solvent, as described above, as well as data obtained from a two-step SLRP™ and ALPHA processing system using acetic acid with water as the solvent.

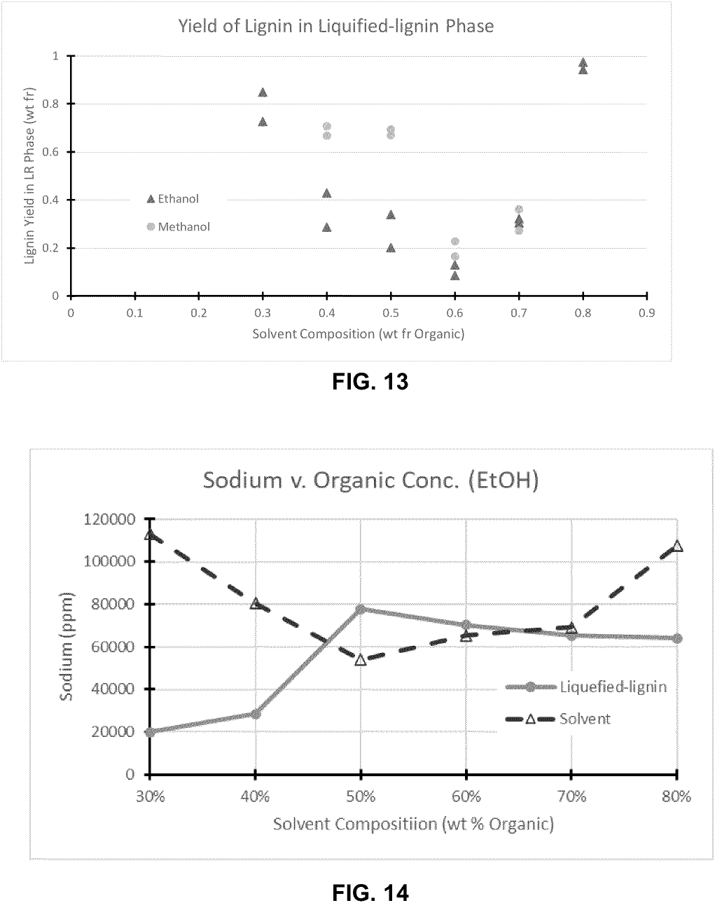

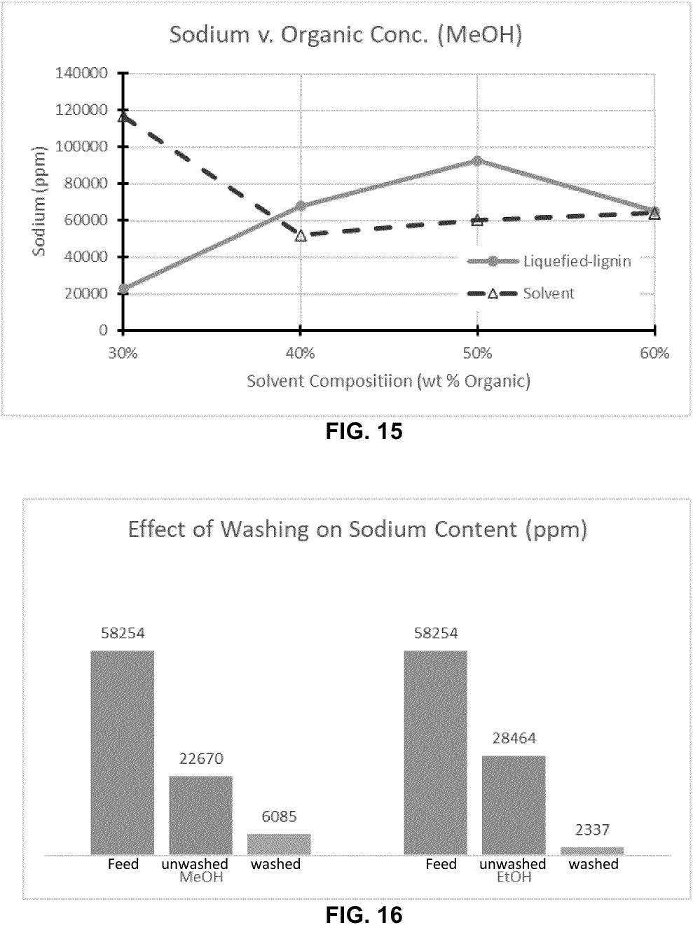

FIG. 13 provides a comparison of the lignin recovery in the lignin-rich phase with increasing solvent concentration for MeOH and EtOH as organic solvents of the solvent solution. FIG. 14 provides a comparison of the Na concentration in the lignin of the lignin-rich phase with increasing solvent concentration EtOH as organic solvent of the solvent solution. FIG. 15 provides a comparison of the Na concentration in the lignin of the lignin-rich phase with increasing solvent concentration MeOH as organic solvent of the solvent solution. FIG. 16 illustrates the sodium content for the different systems in the feed as well as with and without washing of the product. The separations were carried out at 75° C. according to the method as described herein.

While certain embodiments of the disclosed subject matter have been described using specific terms, such description is for illustrative purposes only, and it is to be understood that changes and variations may be made without departing from the spirit or scope of the subject matter.

What is claimed is:

1. A method for lignin recovery comprising:
combining a feed containing lignin and one or more impurities with a solvent solution to form a mixture, the solvent solution including a strong acid at a normality of from about 0.25 N to about 4 N, and an organic solvent, the solvent solution including the organic solvent in an amount of from about 20 wt.% to about 90 wt.% of the solvent solution;
heating and agitating the mixture, upon which the mixture separates to form a liquid/liquid equilibrium including a liquified lignin-rich phase comprising a first portion of the lignin and a solvent-rich phase comprising a second portion of the lignin;
collecting the first portion, wherein the lignin of the first portion will have a higher number average molecular weight as compared to the lignin of the second portion.

2. The method of claim 1, wherein the lignin of the first portion is reduced in content of the impurities as compared to the feed.

3. The method of claim 1, further comprising pre-treating a lignin-containing material to form the feed.

4. The method of claim 3, the pre-treating comprising carbonating a black liquor by a process that includes contacting a black liquor with carbon dioxide.

5. The method of claim 3, the pre-treating comprising contacting a black liquor with sulfuric acid.

6. The method of claim 1, further comprising further processing the first portion of the lignin or the second portion of the lignin.

7. The method of claim 6, the further processing comprising contacting the lignin of the first portion or the lignin of the second portion with an organic solvent in a single or multi-stage treatment process.

8. The method of claim 7, the impurities comprising sodium, and wherein following the further processing, the lignin of the first portion has a sodium content of about 100 ppm or less.

9. The method of claim 6, the further processing comprising washing the lignin of the first portion or the lignin of the second portion.

10. The method of claim 1, the strong acid comprising sulfuric acid.

11. The method of claim 1, the organic solvent comprising an organic acid, an aliphatic alcohol, a ketone, an ether, ethyl acetate, or a mixture thereof.

12. The method of claim 11, the organic solvent comprising acetic acid, ethanol, methanol, or any combination thereof.

13. The method of claim 1, the organic solvent constituting from about 45 wt.% to about 70 wt.% of the solvent solution.

14. The method of claim 1, the strong acid having a normality of from about 0.5 N to about 3 N.

15. The method of claim 1, wherein the feed and the solvent solution are combined such that the wt./wt. ratio of the total solvent content to the lignin plus impurities content in the mixture as formed is from about 3:1 to about 20:1.

16. The method of claim 15, wherein the feed and the solvent solution are combined such that the wt./wt. ratio of the total solvent content to the lignin plus impurities content in the mixture as formed is about 6:1.

17. The method of claim 1, wherein the mixture is heated to a temperature of from about 30° C. to about 250° C.

18. The method of claim 17, wherein the mixture is heated under increased pressure.

19. The method of claim 1, wherein the impurities comprise sodium and ash, the lignin of the first portion containing about 1 wt.% or less ash and a total metals content of about 2,000 ppm or less.
